(19) United States
(12) Patent Application Publication
(10) Pub. No.: US 2025/0293364 A1
(43) Pub. Date: Sep. 18, 2025

(54) ELECTRICITY ACCUMULATION APPARATUS AND METHOD OF MANUFACTURING ELECTRICITY ACCUMULATION APPARATUS

(71) Applicants: TOYOTA JIDOSHA KABUSHIKI KAISHA, Aichi-ken (JP); TOYOTA BATTERY CO., LTD., SHIZUOKA (JP)

(72) Inventors: Kazuhito KATO, Toyota-shi (JP); Yoshiro OBAYASHI, Toyota-shi (JP); Yosuke SHIMURA, Nagakute-shi (JP); Kenta MIYAHARA, Toyohashi-shi (JP); Takuya NOGUCHI, Toyota-shi (JP); Masaya OGURA, Hamamatsu-shi (JP); Yuji KATAYAMA, Okazaki-shi (JP); Ryutaro SUZUKI, Hamamatsu-shi (JP)

(21) Appl. No.: 19/010,165

(22) Filed: Jan. 6, 2025

(30) Foreign Application Priority Data
Mar. 14, 2024 (JP) 2024-039937

(51) Int. Cl. H01M 50/211; H01M 50/244; H01M 50/271; H01M 50/553

(52) U.S. Cl. CPC H01M 50/211; H01M 50/244; H01M 50/271; H01M 50/553

(57) ABSTRACT

An electricity accumulation apparatus includes: a cell joining body (cell module) including a plurality of electricity accumulation cells; and a case that houses the cell joining body. Hole portions (engagement portions) to and from which hooks are attachable and removable are provided in an end portion of the cell joining body in the X-direction (joining direction) (longitudinal direction).

### CROSS-REFERENCE TO RELATED APPLICATION

This application claims priority to Japanese Patent Application No. 2024-039937 filed on Mar. 14, 2024, incorporated herein by reference in its entirety.

### BACKGROUND

### 1. Technical Field

The present disclosure relates to an electricity accumulation apparatus and a method of manufacturing the electricity accumulation apparatus.

### 2. Description of Related Art

In Japanese Unexamined Patent Application Publication (Translation of PCT application) No. 2023-502457 (JP-2023-502457 A), a housing and a battery including a plurality of electrode body sets are disclosed. The electrode body sets are provided in the housing. The electrode body sets are arranged along a first direction and are connected to each other in series.

### SUMMARY

Although not clearly stated in JP-2023-502457 A, the electrode body sets arranged in the first direction may be inserted into the housing along the first direction. In this case, it is desired that the operation of storing the electrode body sets (cell module) into the housing be facilitated.

The present disclosure has been made in order to solve the problem described above and an object thereof is to provide an electricity accumulation apparatus that enables a cell module to be easily stored into a case and a method of manufacturing the electricity accumulation apparatus.

An electricity accumulation apparatus according to a first aspect of the present disclosure includes: a cell module including at least one electricity accumulation cell and having a longitudinal direction; and a case that houses the cell module. An engagement portion to and from which a hook is attached and removed is provided in an end portion of the cell module in the longitudinal direction.

In the electricity accumulation apparatus of the first aspect of the present disclosure, the engagement portion to and from which the hook is attached and removed is provided in the end portion of the cell module in the longitudinal direction as described above. By the above, it becomes possible to easily move the cell module in the longitudinal direction by pulling the hook in the longitudinal direction in a state in which the hook is engaged with the engagement portion. As a result, it becomes possible to easily insert the cell module into the case along the longitudinal direction. By the above, it becomes possible to easily store the cell module into the case.

In the electricity accumulation apparatus according to the first aspect, at least one electricity accumulation cell may include a plurality of electricity accumulation cells. The longitudinal direction is a joining direction in which the electricity accumulation cells are joined to each other. By the configuration as above, it becomes possible to easily insert the electricity accumulation cells into the case along the joining direction.

In the electricity accumulation apparatus according to the first aspect, at least one electricity accumulation cell may have an electrode terminal. The engagement portion includes a hole portion provided in the electrode terminal or an L-shaped or U-shaped protrusion provided on the end portion of the cell module. By the configuration as above, it becomes possible to easily engage the hook with the end portion of the cell module with use of the hole portion provided in the electrode terminal or the protrusion having an L-shape or a U-shape.

In the electricity accumulation apparatus according to the first aspect, one end of the case in the longitudinal direction may be open. The cell module includes a cover member disposed on the end portion. The cover member is configured to close the one end of the case by being joined to the one end. The engagement portion is provided in the cover member. The cover member has a dimension that passes through the inside of the case in the longitudinal direction. By the configuration as above, it becomes possible to cause at least one electricity accumulation cell and the cover member to be moved in the longitudinal direction and pass through the inside of the case by pulling the hook in the longitudinal direction in a state in which the hook is engaged with the engagement portion of the cover member. As a result, it becomes possible to store at least one electricity accumulation cell into the case and close one end of the case by the cover member by moving the cover member to the one end.

A method of manufacturing an electricity accumulation apparatus according to a second aspect of the present disclosure is a method of manufacturing an electricity accumulation apparatus including a cell module. The cell module includes at least one electricity accumulation cell and has a longitudinal direction. The method includes: engaging a hook with an engagement portion provided in an end portion of the cell module in the longitudinal direction; and inserting the cell module into a case by pulling the hook engaged with the engagement portion in the longitudinal direction.

In the method of manufacturing an electricity accumulation apparatus according to the second aspect of the present disclosure, the cell module is inserted into the case as a result of pulling the hook engaged with the engagement portion in the longitudinal direction as described above. By the above, it becomes possible to provide the method of manufacturing an electricity accumulation apparatus that enables the cell module to be easily stored into the case.

According to the present disclosure, it becomes possible to easily store the cell module including at least one electricity accumulation cell into the case.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing a configuration of an electricity accumulation apparatus according to a first embodiment;

FIG. 2 is a view showing a configuration of a cell joining body in the electricity accumulation apparatus according to the first embodiment;

FIG. 3 is a partially enlarged perspective view showing an inner structure of the electricity accumulation apparatus according to the first embodiment;

FIG. 4 is an exploded perspective view showing a configuration of an electricity accumulation cell in the electricity accumulation apparatus according to the first embodiment;

FIG. 5 is a partially enlarged perspective view showing hole portions provided in current collection terminals of the electricity accumulation cells in the electricity accumulation apparatus according to the first embodiment;

FIG. 6 is a flowchart showing a method of manufacturing the electricity accumulation apparatus in the first embodiment;

FIG. 7 is a partially enlarged plan view showing a state in which hooks are engaged with the hole portions in Step S1 in FIG. 6;

FIG. 8 is a sectional view showing a state in which the cell joining body is pulled in Step S2 in FIG. 6;

FIG. 9 is a sectional view showing a state in which a case is closed by a cover member in Step S3 in FIG. 6;

FIG. 10 is a sectional view showing a configuration of an electricity accumulation apparatus according to a second embodiment;

FIG. 11 is a sectional view showing a state in which a cell joining body is pulled in the electricity accumulation apparatus according to the second embodiment;

FIG. 12 is a sectional view showing a state in which a case is closed by a cover member in the electricity accumulation apparatus according to the second embodiment; and

FIG. 13 is a sectional view showing a configuration of an electricity accumulation apparatus according to a modified example of the second embodiment.

### DETAILED DESCRIPTION OF EMBODIMENTS

Embodiments of the present disclosure are described with reference to the drawings. In the drawings referred to below, the same members or members equivalent thereto are denoted by the same numerals.

### First Embodiment

### Configuration of Electricity Accumulation Apparatus

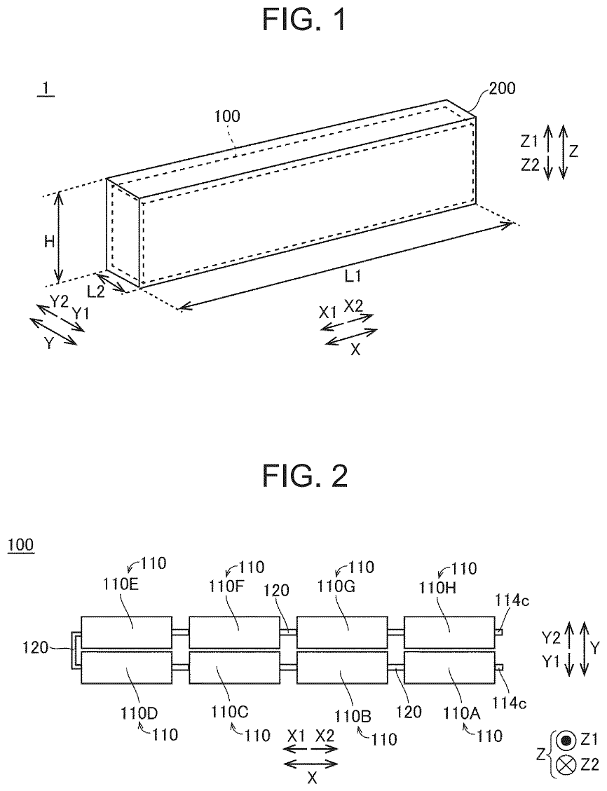

FIG. 1 is a perspective view schematically showing an electricity accumulation apparatus 1 in a first embodiment of the present disclosure. The electricity accumulation apparatus 1 is an apparatus for accumulating driving electricity of an electrified vehicle (not shown), for example. The electricity accumulation apparatus 1 may be provided in an electrical equipment (for example, a stationary electricity accumulation apparatus) other than the electrified vehicle. An X-direction, a Y-direction, and a Z-direction in the present specification are directions orthogonal to each other. For example, the X-direction and the Y-direction may be the front-rear direction and the left-right direction of the electrified vehicle, respectively, when the electricity accumulation apparatus 1 is mounted on the electrified vehicle. The Z-direction may be the vertical direction. The X-direction is one example of “a joining direction” and “a longitudinal direction” of the present disclosure.

As shown in FIG. 1, the electricity accumulation apparatus 1 includes a cell joining body 100 and a case 200. The cell joining body 100 is housed in the case 200. The case 200 is formed by aluminum, for example. The cell joining body 100 is one example of “a cell module” of the present disclosure.

The case 200 is formed in a cuboid shape that is long in the X-direction.

Specifically, the case 200 has a length L1 in the X-direction and has a length L2 in the Y-direction. The length L1 is greater than the length L2. The case 200 has a height H in the Z-direction. The height H is smaller than the length L1. The height H is greater than the length L2. The shape of the case 200 (the magnitude relationship between the dimensions of the respective directions) is not limited to the examples described above.

As shown in FIG. 2, the cell joining body 100 includes a plurality of electricity accumulation cells 110. In the first embodiment, the number of the electricity accumulation cells 110 is eight. However, the number of the electricity accumulation cells 110 is not limited to eight. Examples of each electricity accumulation cell 110 include a lithium-ion battery. Each electricity accumulation cell 110 may be configured by a so-called all-solid-state battery including a solid electrolyte. Each electricity accumulation cell 110 has a shape that extends longer in the X-direction than in the Y-direction and extends longer in the X-direction than in the Z-direction. Each electricity accumulation cell 110 has a shape that extends longer in the Z-direction than in the Y-direction. The cell joining body 100 has a longitudinal direction in the X-direction.

The eight electricity accumulation cells 110 are electrically connected to each other in series. Specifically, the eight electricity accumulation cells 110 include an electricity accumulation cell 110A, an electricity accumulation cell 110B, an electricity accumulation cell 110C, an electricity accumulation cell 110D, an electricity accumulation cell 110E, an electricity accumulation cell 110F, an electricity accumulation cell 110G, and an electricity accumulation cell 110H. The electricity accumulation cells 110A to 110D are arranged in the X-direction. Specifically, the electricity accumulation cell 110A, the electricity accumulation cell 110B, the electricity accumulation cell 110C, and the electricity accumulation cell 110D are disposed in the stated order from the X2 side. The electricity accumulation cells 110E to 110H are arranged in the X-direction. Specifically, the electricity accumulation cell 110E, the electricity accumulation cell 110F, the electricity accumulation cell 110G, and the electricity accumulation cell 110H are disposed in the stated order from the X1 side.

The row of the electricity accumulation cells 110A to 110D and the row of the electricity accumulation cells 110E to 110H are adjacent to each other in the Y-direction. Specifically, the electricity accumulation cell 110A and the electricity accumulation cell 110H are adjacent to each other in the Y-direction. The electricity accumulation cell 110B and the electricity accumulation cell 110G are adjacent to each other in the Y-direction. The electricity accumulation cell 110C and the electricity accumulation cell 110F are adjacent to each other in the Y-direction. The electricity accumulation cell 110D and the electricity accumulation cell 110E are adjacent to each other in the Y-direction.

The electricity accumulation cells 110A to 110D are electrically connected to each other in series by connection portions 120. The electricity accumulation cell 110D and the electricity accumulation cell 110E are electrically connected to each other by the connection portion 120. The electricity accumulation cells 110E to 110H are electrically connected to each other in series by the connection portions 120. The connection portion 120 that electrically connects the electricity accumulation cell 110D and the electricity accumulation cell 110E to each other is bent in a U-shape. The other connection portions 120 are linearly formed.

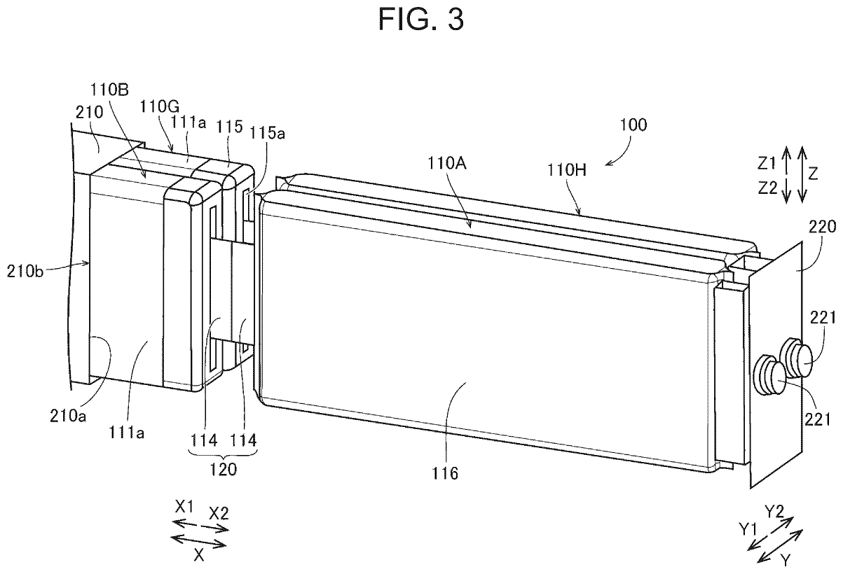

With reference to FIG. 3, the case 200 includes a case body 210 and a cover member 220. The case body 210 is formed in a quadrilateral pipe-shape that is long in the X-direction.

An opening 210a is provided in the case 200 (case body 210). The opening 210a is provided in an end portion 210b of the case body 210 on the X2 side thereof. The cover member 220 is joined to the end portion 210b by welding and the like so as to close the end portion 210b (opening 210a) of the case body 210. The end portion 210b is one example of “one end” of the present disclosure.

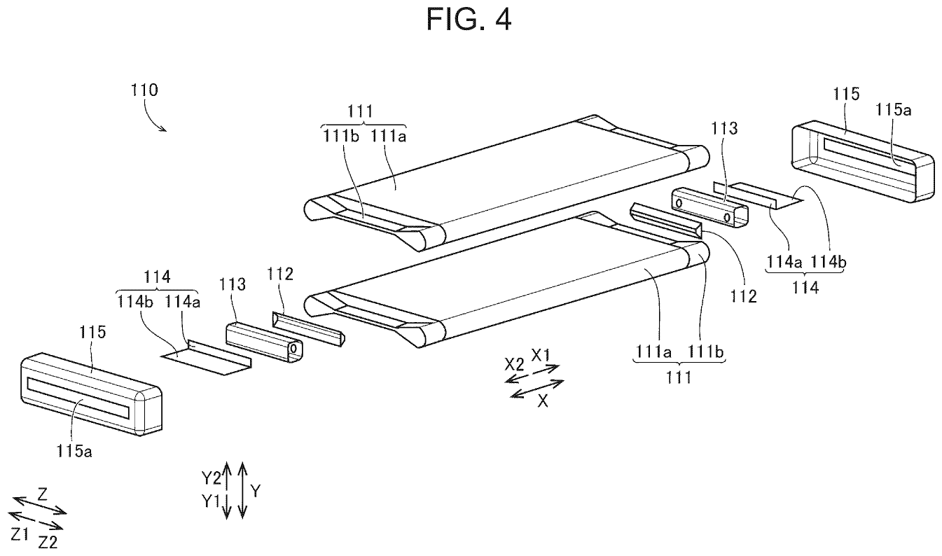

FIG. 4 is an exploded perspective view of the electricity accumulation cell 110. With reference to FIG. 3 and FIG. 4, each electricity accumulation cell 110 has at least one electrode body 111, spacers 112, terminal members 113, current collection terminals 114, covers 115, and a laminate exterior body 116 (FIG. 3). In FIG. 4, the illustration of the laminate exterior body 116 is omitted. In FIG. 3, the illustration of the laminate exterior body 116 of the electricity accumulation cell 110B and the laminate exterior body 116 of the electricity accumulation cell 110G is omitted.

In this example, the electricity accumulation cell 110 includes two electrode bodies 111. However, the number of the electrode bodies 111 is not limited to two. Each electrode body 111 is configured by a wound body obtained by winding a positive electrode sheet and a negative electrode sheet around via a separator. However, each electrode body 111 may be configured by a laminated body obtained by laminating a positive electrode sheet and a negative electrode sheet via a separator. The two electrode bodies 111 are adjacent to each other in the Y-direction in which the positive electrode sheet and the negative electrode sheet are laminated. Each electrode body 111 is formed in a shape that is long in the X-direction.

Each electrode body 111 has a coated portion 111a and electrode tabs 111b. The coated portion 111a is a region in which an active material layer is provided out of an electrode foil in the positive electrode sheet or the negative electrode sheet. The electrode tabs 111b are regions in which the active material layer is not provided out of the electrode foil in the positive electrode sheet or the negative electrode sheet (in other words, uncoated portions in which the electrode foil is exposed).

The spacer 112 is disposed between a pair of electrode tabs 111b adjacent to each other. The spacer 112 is formed by an insulating material (synthetic resin and the like). The spacer 112 has a shape in which the dimension in the Y-direction gradually becomes greater as the distance from the coated portion 111a increases in the X-direction.

The terminal member 113 is connected to an outer side surface of the spacer 112 in the X-direction. The terminal member 113 is formed by a conductive material (metal such as copper and aluminum). The terminal member 113 is connected to the pair of electrode tabs 111b adjacent to each other in the Y-direction.

The current collection terminal 114 is connected to the terminal member 113. The current collection terminal 114 electrically connected to the positive-electrode electrode tab 111b via the terminal member 113 is formed by aluminum, for example. The current collection terminal 114 electrically connected to the negative-electrode electrode tab 111b via the terminal member 113 is formed by copper, for example. The current collection terminal 114 has a connection portion 114a and a projecting portion 114b. Only the electricity accumulation cells 110A and 110H out of the eight electricity accumulation cells 110 have a current collection terminal 114c instead of the current collection terminal 114. The current collection terminals 114c are terminals electrically connected to external terminals 221 (see FIG. 3). Each current collection terminal 114c is provided on an end portion of a corresponding one of the electricity accumulation cells 110A and the electricity accumulation cell 110H on the X2 side thereof. Each current collection terminal 114 is provided on an end portion of a corresponding one of the electricity accumulation cell 110A and the electricity accumulation cell 110H on the X1 side thereof. The current collection terminal 114c is one example of “an electrode terminal” of the present disclosure.

The connection portion 114a is connected to an outer side surface of the terminal member 113 in the X-direction by welding and the like. The connection portion 114a is formed in a flat-plate-shape.

The projecting portion 114b projects outward in the X-direction from the connection portion 114a. The projecting portion 114b is formed in a flat-plate-shape. The electricity accumulation cells 110 to be electrically connected to each other are electrically connected to each other as a result of the projecting portions 114b being connected to each other. The connection portion 120 (FIG. 3) is formed by the projecting portions 114b electrically connected to each other.

The cover 115 covers the end portion (electrode tab 111b) of the electrode body 111 in the X-direction. The cover 115 is formed by an insulating material (synthetic resin and the like). A through-hole 115a through which the projecting portion 114b is inserted is provided in the cover 115.

The laminate exterior body 116 (FIG. 3) houses each electrode body 111, the spacers 112, the terminal members 113, some the current collection terminals 114, and the covers 115. The laminate exterior body 116 is formed by a laminate film.

The external terminals 221 (FIG. 3) are provided on the cover member 220. The external terminals 221 are electrically connected to the current collection terminals 114c of the electricity accumulation cells 110 (electricity accumulation cells 110A and 110H) disposed in positions closest to the cover member 220 out of the electricity accumulation cells 110.

Here, as described above, the cell joining body 100 including the electricity accumulation cells 110 arranged in the X-direction is inserted into the case body 210 at the time of manufacturing. It is desired that the operation of inserting the cell joining body 100 into the case body 210 be facilitated.

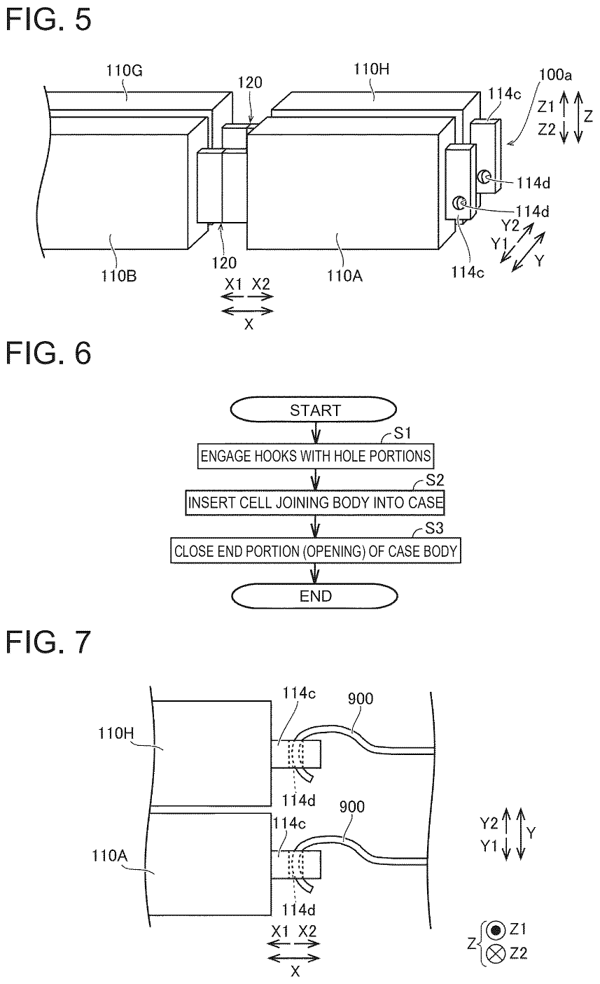

Thus, in the first embodiment, as shown in FIG. 5, hole portions 114d to and from which hooks 900 (see FIG. 7) are attachable and removable are provided in an end portion 100a of the cell joining body 100 in the X-direction. Specifically, each hole portion 114d is provided in the current collection terminal 114c of a corresponding one of the electricity accumulation cell 110A and the electricity accumulation cell 110H. The hole portion 114d is a through-hole that passes through the current collection terminal 114c in the Y-direction. The direction in which the hole portion 114d passes is not limited to the example described above. The hole portion 114d is one example of “an engagement portion” of the present disclosure.

The hole portion 114d is provided in a lower portion of the current collection terminal 114c. Specifically, the hole portion 114d is provided below the center of the current collection terminal 114c in the Z-direction. The expression “below the center of the current collection terminal 114c” means “below the center of the electricity accumulation cell 110A (110H) in the Z-direction”.

Although illustration is omitted, the hole portion 114d may be provided on the X1 side than the center of the current collection terminal 114c in the X-direction (on the electricity accumulation cell side, closer to the electricity accumulation cell). The position of the hole portion 114d in the current collection terminal 114c is not limited to the example described above.

### Method of Manufacturing Electricity Accumulation Apparatus

Next, with reference to FIG. 6 to FIG. 9, a method of manufacturing the electricity accumulation apparatus 1 is described. The method of manufacturing the electricity accumulation apparatus 1 is not limited to the example described below and may be modified, as appropriate.

As shown in FIG. 6, in Step S1, the hooks 900 (see FIG. 7) are engaged with the hole portions 114d. In Step S2, the cell joining body 100 is inserted into the case 200 (case body 210). In Step S3, an end portion (opening) of the case body 210 is closed.

FIG. 7 is a view showing the process of Step S1 in FIG. 6. As shown in FIG. 7, each hook 900 is engaged with the hole portion 114d formed in the current collection terminal 114c of a corresponding one of the electricity accumulation cell 110A and the electricity accumulation cell 110H. Each hook 900 is formed by a member having an insulation property, for example. The hook 900 may be formed by a member made of metal and covered by an insulating tape, for example.

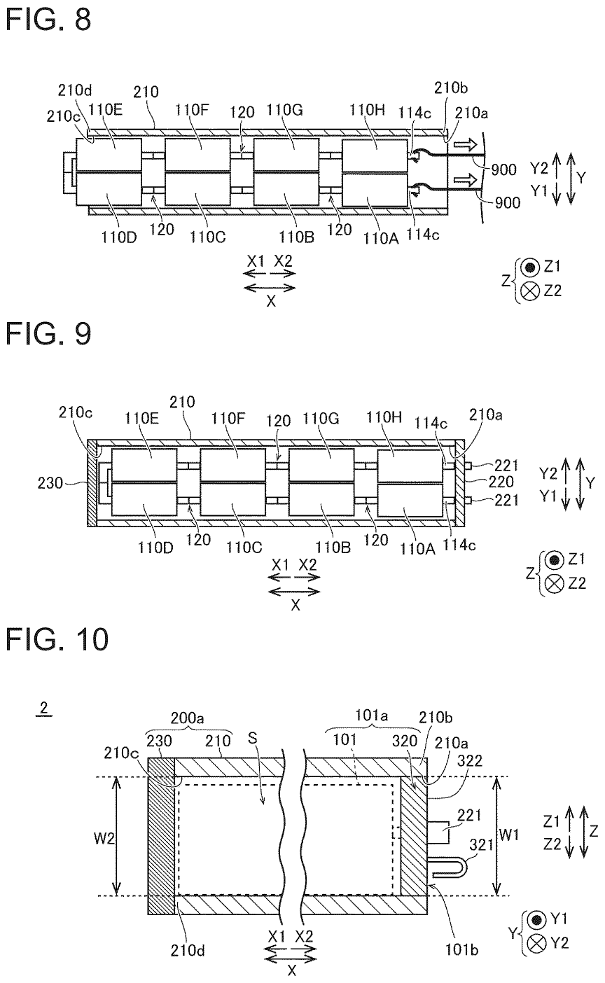

FIG. 8 is a view showing the process of Step S2 in FIG. 6. As shown in FIG. 8, the cell joining body 100 is inserted from an opening 210c of the case body 210 on the side opposite from the opening 210a. The opening 210c is provided in an end portion 210d of the case body 210 on the X1 side thereof. For example, the hooks 900 are pulled to the X2 side (the arrow direction in FIG. 8) in a state in which the end portion 100a (FIG. 5) of the cell joining body 100 on the X2 side is inserted into the case body 210 from the opening 210c. By the above, the entire cell joining body 100 is inserted into the case body 210.

FIG. 9 is a view showing the process of Step S3 in FIG. 6. As shown in FIG. 9, the end portion 210b (opening 210a) of the case body 210 is closed by the cover member 220. The end portion 210d (opening 210c) of the case body 210 is closed by the cover member 230. The cover member 220 and the cover member 230 are joined to an edge portion (end portion 210b) of the opening 210a and an edge portion (end portion 210d) of the opening 210c, respectively, by welding, for example. The cover member 220 is greater than the opening 210a. Specifically, the width of the cover member 220 is greater than the width of the opening 210a in each of the Y-direction and the Z-direction. Similarly, the width of the cover member 230 is greater than the width of the opening 210c in each of the Y-direction and the Z-direction.

As above, in the electricity accumulation apparatus 1 in the first embodiment, the hole portions 114d to and from which the hooks 900 are attachable and removable are provided in the end portion 100a of the cell joining body 100 in the X-direction. By the above, the electricity accumulation cells 110 (cell joining body 100) can be integrally moved in the X-direction as a result of pulling the hooks 900 engaged with the hole portions 114d in the X-direction. As a result, the cell joining body 100 can be easily inserted into the case 200.

### Second Embodiment

Next, with reference to FIG. 10 to FIG. 12, a second embodiment of the present disclosure is described. The second embodiment is different from the first embodiment in which the hole portions 114d (engagement portions) are formed in the current collection terminals 114c of the electricity accumulation cell 110. In the second embodiment, an engagement portion is provided in a cover member 320. Configurations that are the same as those in the first embodiment are denoted by the same reference characters and description is not repeated.

### Configuration of Electricity Accumulation Apparatus

As shown in FIG. 10, an electricity accumulation apparatus 2 includes a cell module 101a and a case 200a. The cell module 101a includes a cell joining body 101 and a cover member 320. The case 200a is configured by a case body 210 and a cover member 230.

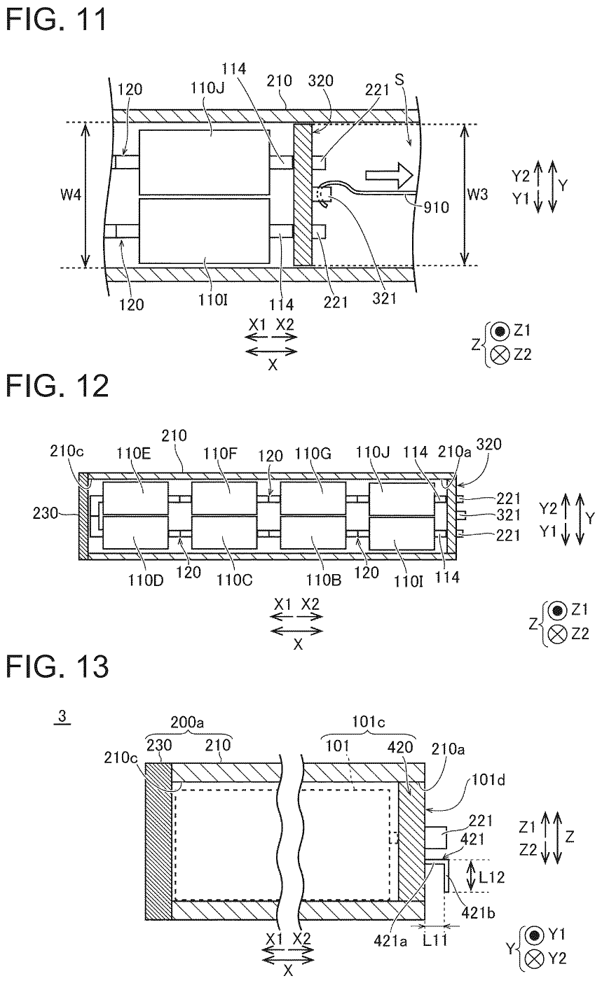

The cell joining body 101 is different from the cell joining body 100 of the first embodiment in that the cell joining body 101 includes an electricity accumulation cell 110I (FIG. 11) instead of the electricity accumulation cell 110A of the first embodiment and includes an electricity accumulation cell 110J (FIG. 11) instead of the electricity accumulation cell 110H of the first embodiment. Each of the electricity accumulation cell 110I and the electricity accumulation cell 110J is disposed to be the closest to the X2 side (the side of an end portion 101b of the cell module 101a) out of the electricity accumulation cells 110. Each of the electricity accumulation cell 110I and the electricity accumulation cell 110J has the same configuration as the electricity accumulation cells 110B to 110G.

The cover member 320 is joined (fixed) to the cell joining body 101 by welding and the like. Specifically, the cover member 320 is joined (fixed) to each of the electricity accumulation cell 110I and the electricity accumulation cell 110J. In other words, the cover member 320 is provided on the end portion 101b of the cell module 101a on the X2 side thereof. The cover member 320 may be directly joined to the cell joining body 101 or may be indirectly joined to the cell joining body 101 via another member.

The cover member 320 is joined to the end portion 210b of the case 200a (case body 210). The cover member 320 is provided so as to close the end portion 210b (opening 210a). In other words, the cover member 320 forms a space for housing the cell joining body 101 with the case 200a.

A protrusion 321 is provided on the cover member 320. The protrusion 321 is provided on a front surface 322 of the cover member 320 that is on the side (X2 side) opposite from the cell joining body 101. The protrusion 321 is integrally provided with the cover member 320. The protrusion 321 may be a body separate from the cover member 320. In this case, the protrusion 321 may be fastened to the cover member 320, for example. The protrusion 321 is formed by metal (aluminum and the like), for example. The protrusion 321 is one example of “an engagement portion” of the present disclosure.

The protrusion 321 is provided to protrude from the front surface 322 to the side (X2 side) opposite from the cell joining body 101. The external terminal 221 is also provided to protrude from the front surface 322 to the X2 side.

The protrusion 321 has a U-shape (or a J-shape). Specifically, the protrusion 321 has a U-shape of which X2 side is the lower side.

The protrusion 321 is disposed on the Z2 side (lower side) of the position in which the external terminal 221 is provided in the Z-direction. The position in which the protrusion 321 is disposed may be positions other than that described above.

In the second embodiment, the cover member 320 has a dimension that can pass through the inside of the case 200a (case body 210) in the X-direction. Specifically, the cover member 320 has a width W1 in the Z-direction. A space S (a space for housing the cell joining body 101) in the case body 210 has a width W2 in the Z-direction. The width W2 is equal to or more than the width W1.

The cover member 320 has a width W3 (FIG. 11) in the Y-direction. The space S in the case body 210 has a width W4 in the Y-direction. The width W4 is equal to or more than the width W3.

### Method of Manufacturing Electricity Accumulation Apparatus

Next, with reference to FIG. 11 and FIG. 12, a method of manufacturing the electricity accumulation apparatus 2 is described. The flow of the manufacturing method is similar to that of the first embodiment (FIG. 6).

FIG. 11 is a view showing a process (equivalent to Step S2 in the first embodiment) of inserting the cell module 101a into the case 200a (case body 210). As shown in FIG. 11, in the second embodiment, the electricity accumulation cells 110 and the cover member 320 are integrally inserted into the case body 210 as a result of the hook 910 being pulled to the X2 side in a state in which the hook 910 is engaged with the protrusion 321.

FIG. 12 is a view showing a process (equivalent to Step S3 in the first embodiment) of closing an end portion (opening) of the case body 210. As shown in FIG. 12, in the second embodiment, the end portion 210b (opening 210a) is closed by the cover member 320. At this time, in order to fill in a gap between the end portion 210b and the cover member 320, welding may be performed with use of a metallic plate (patch) having a shape (for example, an annular shape) corresponding to the gap.

Other configurations and processing are similar to those of the first embodiment, and hence description is not repeated.

In the second embodiment, an example in which the protrusion 321 having a U-shape is provided on the end portion 101b of the cell module 101a has been shown, but the present disclosure is not limited thereto. The shape of the protrusion is not limited to the U-shape.

For example, in an example shown in FIG. 13, a protrusion 421 having an L-shape is provided on an end portion 101d of a cell module 101c included in an electricity accumulation apparatus 3. The protrusion 421 is provided on a cover member 420. The protrusion 421 has a portion 421a and a portion 421b. The portion 421a extends in the X-direction. The portion 421b extends in the Z-direction. The portion 421a has a length L11 in the X-direction. The portion 421b has a length L12 in the Z-direction. The length L12 is greater than the length L11. By the above, it becomes possible to reduce cases in which the hook comes off from the protrusion 421. Other configurations are similar to those of the second embodiment. The protrusion 421 is one example of “an engagement portion” of the present disclosure.

In the first embodiment, an example in which the hole portions 114d to be engaged with the hooks 900 are provided in the current collection terminals 114c of the electricity accumulation cells 110 has been shown, but the present disclosure is not limited thereto. For example, a hole portion may be provided in the cover member 220 that closes the end portion 210b (opening 210a). A hole portion may be provided in the external terminal 221 provided on the cover member 220. A protrusion having a U-shape or an L-shape may be provided on the current collection terminal 114 or the external terminal 221.

For example, a hole portion and the like for engaging a hook therewith may be provided in the laminate exterior body 116 (FIG. 3).

In the first embodiment, an example in which the cell joining body 100 is pulled by the hooks 900 from the side (X2 side) on which the electricity accumulation cell 110A and the electricity accumulation cell 110H are provided has been shown, but the present disclosure is not limited thereto. The cell joining body 100 may be pulled by hooks from the side (X1 side) on which the electricity accumulation cell 110D and the electricity accumulation cell 110E are provided. For example, a hook may be engaged with an engagement portion (a groove portion, a hole portion, an uneven portion, and the like) provided in the connection portion 120 that connects the electricity accumulation cell 110D and the electricity accumulation cell 110E to each other.

In the second embodiment, an example in which the cover member 320 can pass through the inside of the case 200a as a result of the width W1 (FIG. 10) and the width W3 (FIG. 11) of the cover member 320 being smaller than the width W2 and the width W4 of the space S in the case 200a, respectively, has been shown but the present disclosure is not limited thereto. For example, a cover member that is elastically deformable may be inserted into the case while being elastically deformed.

In the first and second embodiments, an example in which the cell joining body 100 (101) includes the electricity accumulation cells 110 has been shown, but the present disclosure is not limited to thereto. For example, the number of the electricity accumulation cells included in the electricity accumulation apparatus may be one. The one electricity accumulation cell may be configured by a laminated body obtained by laminating a positive electrode sheet and a negative electrode sheet via a separator.

The configurations of the embodiments and various modified examples may be combined with each other.

It is to be understood that the embodiments disclosed above are merely examples in all aspects and in no way intended to limit the disclosure. The scope of the present disclosure is defined not by the embodiments described above but by the scope of the claims. All modifications made within the scope and spirit equivalent to those of the claims are intended to be included in the disclosure.

What is claimed is:

1. An electricity accumulation apparatus, comprising:
a cell module including at least one electricity accumulation cell and having a longitudinal direction; and
a case that houses the cell module, wherein
an engagement portion to and from which a hook is attached and removed is provided in an end portion of the cell module in the longitudinal direction.

2. The electricity accumulation apparatus according to claim 1, wherein:
the at least one electricity accumulation cell includes a plurality of electricity accumulation cells; and
the longitudinal direction is a joining direction in which the electricity accumulation cells are joined to each other.

3. The electricity accumulation apparatus according to claim 1, wherein:
the at least one electricity accumulation cell has an electrode terminal; and
the engagement portion includes a hole portion provided in the electrode terminal or an L-shaped or U-shaped protrusion provided on the end portion of the cell module.

4. The electricity accumulation apparatus according to claim 1, wherein:
one end of the case in the longitudinal direction is open;
the cell module includes a cover member disposed on the end portion;
the cover member is configured to close the one end of the case by being joined to the one end;
the engagement portion is provided in the cover member; and
the cover member has a dimension that passes through an inside of the case in the longitudinal direction.

5. A method of manufacturing an electricity accumulation apparatus including a cell module, the cell module including at least one electricity accumulation cell, the cell module having a longitudinal direction, the method comprising:
engaging a hook with an engagement portion provided in an end portion of the cell module in the longitudinal direction; and
inserting the cell module into a case by pulling the hook engaged with the engagement portion in the longitudinal direction.
